(19) United States
(12) Patent Application Publication
(10) Pub. No.: US 2015/0305832 A1
(43) Pub. Date: Oct. 29, 2015

(54) SYSTEM FOR MOVING AND ALIGNING TEETH

(71) Applicant: Ruchir Patel, Aurora, IL (US)

(72) Inventor: Ruchir Patel, Aurora, IL (US)

(21) Appl. No.: 14/262,843

(22) Filed: Apr. 28, 2014

(51) Int. Cl. A61C 7/08; A61C 7/28

(52) U.S. Cl. CPC A61C 7/08; A61C 7/282

(57) ABSTRACT

A system and assembly for moving and aligning teeth is disclosed. The system comprises multiple plastic trays and caps that are formed to provide required mobility to a patient's back teeth. These molds are adapted to be placed over and apply a modest force on any out of alignment back teeth. The molds are adapted to be replaced on a regular basis, such as once every thirty days, or as needed. The system further comprises two sets of plastic caps adapted to be disposed over the patient's front teeth. Each set of caps is joined by a nitonol wire that is disposed to join all of the caps. The nitonol wire is coupled to the caps by, for example, brackets that are disposed on the caps. The nitonol wire is adapted to provide a modest force on the teeth that have individual caps, thereby straightening and aligning them.

### CROSS REFERENCE TO RELATED APPLICATIONS

None

### FIELD OF THE DISCLOSURE

The present disclosure generally relates to orthodontics. More particularly, the present disclosure relates to a system and assembly for repositioning teeth through the application of modest force on out-of-position teeth so that the out-of-position teeth are moved from their initial position to a final position.

### BACKGROUND

Repositioning teeth for aesthetic or other purposes is generally accomplished through the use of various orthodontic appliances. Traditional braces are still widely used. Braces comprise a variety of components, such as brackets, archwires, ligatures, and O-rings. Generally, attaching the components to a patient's teeth is a time consuming and tedious process requiring multiple sessions between a patient and orthodontist. Given the numerous meetings between patient and orthodontist, and the multiple orthodontic treatments, braces can be quite expensive.

Generally before fastening braces to a patient's teeth, at least one appointment is scheduled with the orthodontist so that x-rays and photographs of the patient's teeth and jaw structure can be taken. At the same meeting, a mold of the patient's teeth is often taken as well that the orthodontist can use in conjunction with the x-rays to formulate a treatment strategy. The orthodontist then schedules multiple meetings with the patient to put the braces onto the patient's teeth.

At the initial meeting where braces are bonded to the patient's teeth, the surfaces are generally treated first with a weak acid, which optimizes the adhesion properties of the teeth surfaces for the brackets and bands that are to be bonded to them. The brackets and bands are then cemented to the patient's teeth using a suitable bonding material.

Generally, an archwire, which can be constructed of a nickel titanium alloy is used to provide a straightening force on the patient's teeth. The archwire is passed through the brackets over the patient's teeth. It is sized to stretch over the patient's non-straight teeth; therefore, as the teeth are straightened, slack develops in the wire. As slack develops the ends of the wire can protrude past the last bracket installed on the patient's teeth, and cause cuts or discomfort. Accordingly, as the patient's teeth straighten, additional visits to the orthodontist are required, some of which may be emergencies required to alleviate the patient's discomfort. In addition, braces also interfere with a patient's ability to brush, floss, and perform other dental hygiene.

Another assembly used to straighten teeth is the Invisalign system. This system uses a series of sets of plastic trays (called aligners), each of which is designed to exert force on a patient's teeth to move then from an initial unstraightened configuration to a final straightened configuration. However, Invisalign treatment takes longer than the traditional wire and brace system to correct an initial crowding of teeth. It is also hard to extrude teeth; i.e., to bring teeth toward biting surface from gum surface; due to the lack of extruding forces as no wire is utilized. In fact, Invisalign barely accomplishes its goals as it takes an extensive time period and a number of trays to extrude teeth.

### OBJECTS OF THE DISCLOSED SYSTEM

Accordingly, it is an object of this disclosure to provide an improved assembly for moving and aligning teeth from an initial unstraightened configuration to a final straightened configuration.

Another object of the disclosed system is to provide an assembly for moving and aligning teeth that minimizes patient meetings with the orthodontist.

Another object of the disclosed system is to provide an assembly for moving and aligning teeth that eliminates emergency patient meetings with the orthodontist.

Another object of the disclosed system is to provide an assembly for moving and aligning teeth that allows a patient to utilize standard dental hygiene.

Another object of the disclosed system is to provide a fully removable assembly for moving and aligning teeth.

Other advantages of this disclosure will be clear to a person of ordinary skill in the art. It should be understood, however, that a system or method could practice the disclosure while not achieving all of the enumerated advantages, and that the protected disclosure is defined by the claims.

### SUMMARY OF THE DISCLOSURE

An improved system and assembly for repositioning teeth from an initial tooth arrangement to a final tooth arrangement is disclosed. The assembly comprises a plurality of trays that are shaped to apply straightening force as needed to a patient's upper and lower back teeth. In addition, the assembly includes an upper set of caps and a lower set of caps. It should be noted that the term cap, as used herein, does not refer to a porcelain or metallic crown for permanent placement over a tooth. Each of the individual caps in a set of caps is designed to fit over a specific tooth of a patient. Individual caps may have composite attachments placed on teeth for added retention if and as needed to provide added retention when a cap is worn on tooth by a patient. The caps are joined by an archwire, which is adapted to provide straightening force on the patient's front teeth, over which the caps are designed to be disposed. Each cap incorporates a guide on the front through which the archwire can pass A pair of most distal brackets or tubes are disposed on the left and right trays, and the archwire is disposed so that it terminates at the most distal brackets. This allows a patient to remove the entire apparatus in one action, and thereby utilize standard hygiene practices.

In further developed embodiments of the disclosed system, the system includes a lower left tray, a lower right tray, an upper left tray, and an upper right tray. The trays can be constructed of an elastomeric polymeric shell. In addition, the caps adapted to be placed on a patient's front teeth can also be constructed of an elastomeric polymeric shell. Further, the archwire can be constructed of a nickel titanium alloy, and even be constructed of nitonol. In addition, the wire guide disposed on each cap can be 1) a metal bracket having a center cavity and a movable front gate or 2) a tube which can hold the wire. The guide can be an orthodontic bracket or a tube or a combination of both as explained above. The guide will mainly serve the purpose of holding the cap with the wire to exert proper and required pressure or anchorage on teeth needing alignment when the system is placed on the teeth. This wire can be on the buccal (cheek side) side of the apparatus or on the lingual. The guides (brackets or tubes) may also have hooks as needed for a patient to wear rubber bands during orthodontic treatment to correct certain type of mal occlusions.

### BRIEF DESCRIPTION OF THE DRAWINGS

Although the characteristic features of this disclosure will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1A is a top view of a pair of the components of the disclosed assembly for moving a patient's lower teeth, including a pair of plastic trays adapted to move and align the patient's back teeth and a set of caps joined by an archwire adapted to move and straighten the patient's front teeth;

FIG. 1B is a perspective view of the components of the disclosed assembly for moving a patient's lower teeth;

FIG. 2A is a front view of a set of caps joined by an archwire and adapted to move and align a patient's front teeth wherein brackets mounted on each cap are in an open position;

FIG. 2B is a front view of a set of caps joined by an archwire and adapted to move and align a patient's front teeth wherein brackets mounted on each cap are in a closed position;

FIG. 2C is a front view of a set of caps joined by an archwire and adapted to move and align a patient's front teeth wherein tubes disposed in the front of each cap are used to guide the archwire; and

FIG. 3 is a side view of a cap with a bracket mounted on its front as disclosed herein.

### DETAILED DESCRIPTION

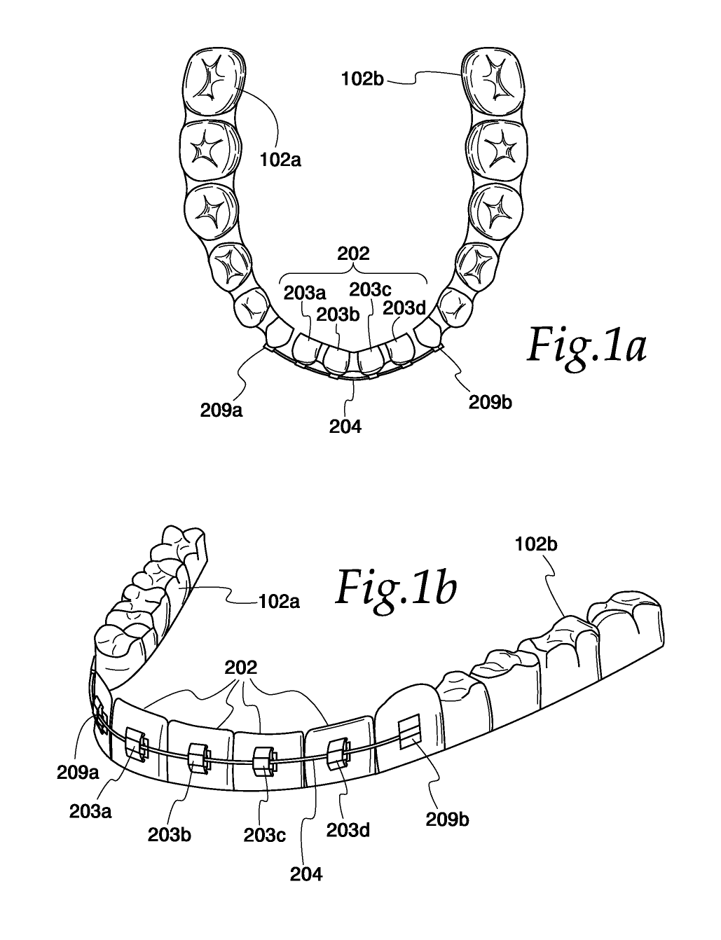

Turning to the Figures and to FIG. 1A in particular, a top view of a part of a system for moving and aligning teeth. In specific, FIG. 1A depicts the components of the system adapted for straightening the lower teeth of a particular patient. Two of the components are a lower left tray 102a and a lower right tray 102b. The component also comprises an upper left tray and upper right tray that are not depicted. Each of the trays is especially formed to mate with a particular set of teeth; i.e., the lower left teeth of a patient, the upper right teeth of a patient, etc. In particular, the upper left tray (not shown) is designed to fit over the teeth in the upper left of a patient's mouth, the upper right tray (not shown) is designed to fit over the teeth in the upper right of a patient's mouth, the lower left tray 102a is designed to fit over the teeth in the lower left of a patient's mouth, and the lower right tray 102b is designed to fit over the teeth in the lower right of a patient's mouth.

Each of the trays can fit over the rear teeth of a quadrant of a patient's jaw. Generally, the rear teeth of a patient will require less correction than the front teeth of the patient; i.e., they will be in better alignment than the front teeth. The trays 102a, 102b can be formed of a polymeric plastic, or other materials that are safe for use in a patient's mouth as are known in the art. The polymeric plastic can be clear or white in color for aesthetic purposes.

FIG. 1A also depicts the top view of a set of caps 202 adapted to fit over the front teeth of a particular patient. As with the trays, the set of caps 204 is especially designed to fit over a particular patient's teeth. Each of the caps 203a,b,c,d is joined with the others by an archwire 204. A pair of most distal brackets 209a and 209b are disposed at the ends of the archwire 204. The most distal brackets are placed to accept slack in the archwire, thereby protecting the patient from scratches and cuts as the archwire lengthens due to the patient's teeth straightening. The most distal brackets 209a and 209b are disposed on the lower left tray 102a and lower right tray 102b respectively, thereby allowing the entire system to be snapped in and out by a patient as a single apparatus. In particular, the trays act as anchors to join the caps to the trays. However, this is not a required feature of the disclosed assembly, and the caps can function without the trays, and vice verse.

FIG. 1B depicts a perspective view of the components of the disclosed teeth straightening assembly used to straighten and align a patient's lower teeth. As with the top view, a set of trays 102a, 102b adapted to straighten a particular patients teeth are depicted. In addition, a set of caps 202 adapted to straighten a particular patients front teeth is depicted. Each of the individual caps 203a,b,c,d in the set of caps 202 is joined by an archwire 204, at the ends of which are a pair of most distal brackets 209a,209b. The most distal brackets 209a,209b are disposed forward of the back of a patient's mouth so that as the patient's teeth straighten and additional slack in the archwire 204 is created, the slack will not reach a dangerous length unless not addressed for a very long time. This should greatly reduce or even eliminate emergency orthodontist trips by patients that use the disclosed assembly for moving teeth. Each of the caps 203a-d can be constructed of a polymeric plastic, or other material safe for use in a patient's mouth, as known in the art. The polymeric plastic can be clear or white in color for aesthetic purposes. The interior of the caps is hollow, and is adapted to fit over a particular tooth.

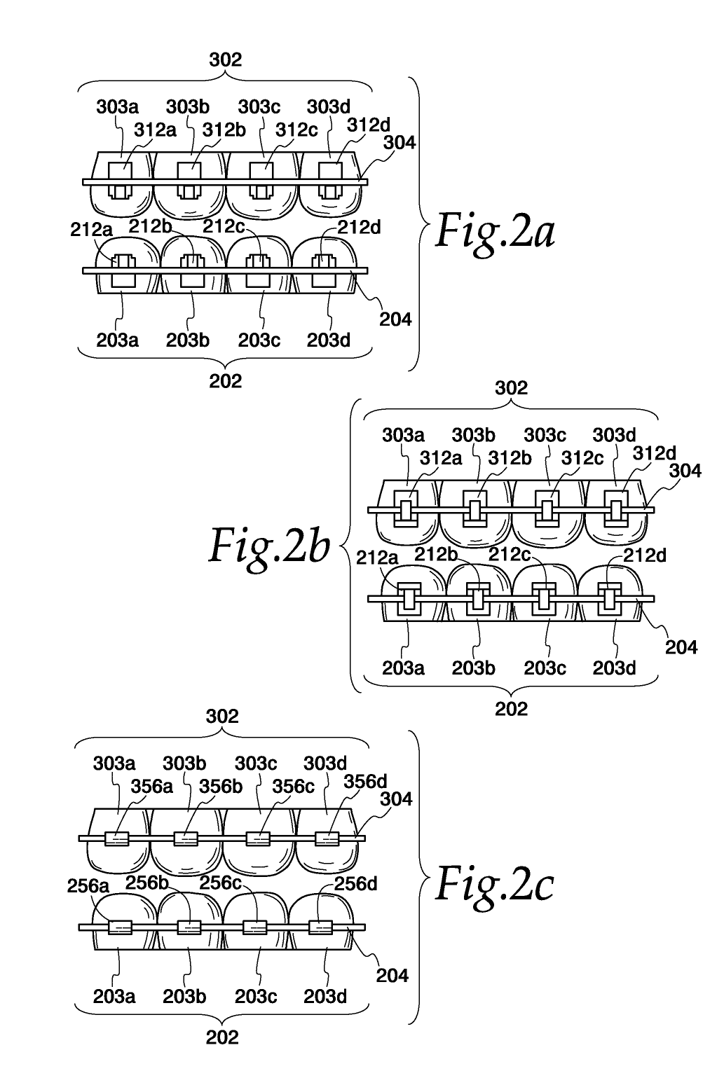

FIG. 2A depicts a front view of a complete set of caps 202, 302 constructed in accordance with this disclosure, with each cap 203a-d, 303a-d incorporating an orthodontic bracket 212a-d, 312a-d on the front of each cap. As depicted each set of caps 202, 302 is constructed to mate with the front four upper and lower teeth of a patient. It should be noted that the same design could also incorporate other teeth, such as the front six upper and lower teeth of a patient. In particular, the caps designed to fit over the patient's lower teeth are denominated as 203a-d and the caps designed to fit over the patient's upper teeth are denominated as 303a-d. As depicted, the brackets 212a-d, 312a-d illustrated in FIG. 2A are in an open position, allowing an archwire 204, 304 to be inserted into the brackets 212a-d, 312a-d, removed from the brackets 212a-d, 312a-d, or to be adjusted as needed. It should be noted that individual caps will be only made for teeth that require movement (in most cases they will be anterior or front teeth) as well as the teeth that are mesial and distal to those that require straightening. The caps will then be supplied to the patient by her orthodontist, and applied to individual teeth by the patient. Rear teeth that do not require substantial movement or straightening will utilize a tray as described above.

FIG. 2B is the same as FIG. 2A, except that the brackets 212a-d, 312a-d are shown in a closed position.

FIG. 2C illustrates an alternative embodiment of the set of caps 202, 302, wherein each cap 203a-d,303a-d has a disposed on it. In particular, caps 303a-d have corresponding tubes 356a-d formed into the front of them, and caps 203a-d have corresponding tubes 256a-d formed into the front of them. Each tube 256a-d, 356a-d can be formed of the same material as the caps 203a-d, 303a-d. Alternatively, the tubes 256a-d,356a-d can be metal that is bonded to the front of the caps 203a-d,303a-d using any prior art method of bonding metal to plastic that is safe for use in a patient's mouth. The metal comprising the tubes 256a-d,356a-d can be white in color for aesthetic purposes.

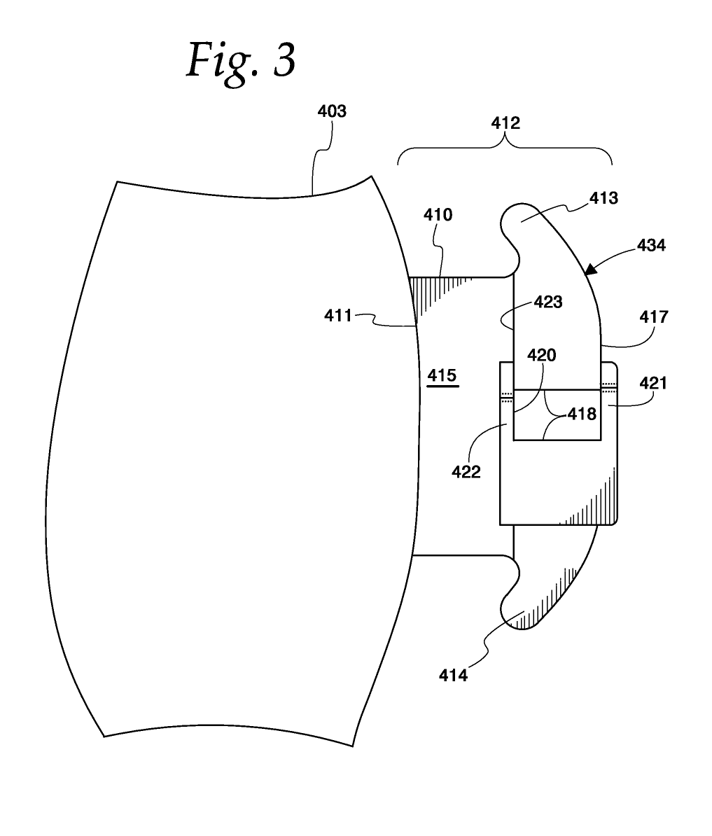

FIG. 3 illustrates a single tooth cap 403 with a bracket 412 attached to it. The bracket 412 can be constructed in accordance with any prior art method, such as that disclosed in U.S. Pat. No. 5,466,151, which is hereby incorporated by reference in its entirety. As illustrated, the bracket 412 comprises a supportive base 410 having a posterior surface 411 which is bonded to the cap 403 using any prior art method of bonding a metal surface to a plastic surface that is safe for use within a patient's mouth.

A pair of lugs 434 project anteriorly from base 410. Each lug 434 includes opposed extensions 413 and 414 that project outwardly between transversely spaced side surfaces formed on the bracket 412. The tying lugs each include an outer side surface 415.

The bracket 412 also includes an anterior surface 417 across the front of each tying lug 434. The anterior surface 417 is illustrated as being planar, but can be curved as well. It is not interrupted by the opening of a transverse archwire slot formed distally from the anterior surface 417. The archwire slot spans the full width of the bracket 412.

The archwire slot includes side slot surfaces 418 and an anterior slot surface 420. The slot surfaces 418 and 420 are sized to accept an archwire (not shown). A closure complementary to the archwire slot is also provided on the bracket. It includes a movable cover 421 that slidably engages the anterior surface 417. Cover 421 has a width that spans the full width of the tying lugs 434. Its perpendicular width is greater than the corresponding width across the archwire slot at the anterior surface 417 of the bracket 412.

The disclosed assembly is intended to be used by orthodontists in treating their patients. The first step in using the assembly is to obtain a representation of the patient's teeth. The representation can be obtained, for example, by using x-rays, three-dimensional x-rays, computer aided tomographic images, magnetic resonance images, or other means. However, the usual way of obtaining a representation of a patient's teeth will be to take a plaster cast of the patient's teeth using well known techniques. Once the cast is taken, a digital representation can be made if desired. The digital representation can be used to create a set of trays to translate the patient's back teeth, both lower and upper, from their initial position to the planned straightened position. As most persons will have relatively straight teeth, generally only one set of trays will be required to translate their back teeth into alignment.

In addition, the digital representation can be used to create the initial sets of caps, and plan the length of the archwire used to join the caps and produce straightening force upon a patient's front teeth.

The disclosed assembly incorporates the advantages of braces; i.e., the use of an archwire to (relatively) quickly move out of position teeth into alignment, while allowing the patient to easily remove and deploy the assembly, much like the Invisalign system and other systems based on the Invisalign system. The easy removal and deployment of the system allows the patient to use standard hygiene.

The foregoing description of the disclosure has been presented for purposes of illustration and description, and is not intended to be exhaustive or to limit the disclosure to the precise form disclosed. The description was selected to best explain the principles of the present teachings and practical application of these principles to enable others skilled in the art to best utilize the disclosure in various embodiments and various modifications as are suited to the particular use contemplated. It is intended that the scope of the disclosure not be limited by the specification, but be defined by the claims set forth below. In addition, although narrow claims may be presented below, it should be recognized that the scope of this invention is much broader than presented by the claim(s). It is intended that broader claims will be submitted in one or more applications that claim the benefit of priority from this application. Insofar as the description above and the accompanying drawings disclose additional subject matter that is not within the scope of the claim or claims below, the additional inventions are not dedicated to the public and the right to file one or more applications to claim such additional inventions is reserved.

What is claimed is:

1. An assembly for repositioning teeth from an initial tooth arrangement to a final tooth arrangement:
i) a plurality of trays wherein each tray is shaped to apply force to a plurality of back teeth of a particular patient to move the plurality of back teeth from an initial arrangement to a desired arrangement;
ii) one or more sets of caps wherein each set of caps is adapted to fit over a patient's upper front teeth or a patient's lower front teeth;
iii) each cap of each set of caps being adapted to fit over a specific front tooth;
iv) each cap of each set of caps having a front surface and a wire aperture disposed on the front surface;
v) a plurality of archwires wherein each archwire joins a set of caps through the wire receptacles on the front surfaces of the caps in the set;
vi) each set of caps having a pair of wire guides disposed to accept wire from each end of the archwire; and
vii) wherein each set of caps is adapted to be attached and detached from either a patient's upper front teeth or a patient's lower front teeth.

2. The assembly of claim 1 wherein the plurality of trays comprises a lower left tray, a lower right tray, an upper left tray, and an upper right tray.

3. The assembly of claim 1 wherein each of the plurality of trays is constructed of an elastomeric polymeric shell.

4. The assembly of claim 1 wherein each cap is constructed of an elastomeric polymeric shell.

5. The assembly of claim 1 wherein each archwire is constructed of a nickel titanium alloy.

6. The assembly of claim 1 wherein each archwire is constructed of nitonol, tma (titanium melledeum alloy) or stainless steel wire.

7. The assembly of claim 1 wherein each wire aperture is a bracket having a center cavity and a movable front gate.

8. The assembly of claim 1 wherein each wire aperture is a tube formed into the front of the cap.

9. The assembly of claim 1 wherein each tray includes a most distal bracket adapted to receive an end of an archwire and wherein each of the plurality of archwires terminates in a most distal bracket.

10. The assembly of claim 1 wherein each tray includes a most distal tube adapted to receive an end of an archwire and wherein each of the plurality of archwires terminates in a most distal tube.
